(19) United States
(12) Patent Application Publication
(10) Pub. No.: US 2008/0038033 A1
(43) Pub. Date: Feb. 14, 2008

(54) METHOD AND SYSTEM FOR MANAGING PRINTER PAPER CONDITIONS

(75) Inventors: Phuc Ky Do, Morrisville, NC (US); Bobby R. Hargett, Raleigh, NC (US); Justin M. Pierce, Cary, NC (US); Javier H. Santiago, Wake Forest, NC (US)

Correspondence Address: CANTOR COLBURN LLP - IBM RESEARCH TRIANGLE PARK, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/463,047

(22) Filed: Aug. 8, 2006

(51) Int. Cl. B41J 29/38

(52) U.S. Cl. 400/76

(57) ABSTRACT

A method and system for managing printer paper conditions is provided. The method includes monitoring states of a paper source in a point-of-sale (POS) printer by a light source and sensor mounted in the paper source, the light source emitting light. A low paper state is determined when a low reflection is detected by the sensor, the low reflection resulting from light reflecting off of a colored portion of a paper roll when the light source and the sensor are positioned on the same side of the paper roll. The colored portion is provided along a margin at the low end of the paper roll. The method further includes tracking a motor step count of the paper source in response to the low paper state to determine a current amount of paper remaining on the paper roll, and transmitting a notification to a system that manages the POS printer informing the system of the current amount of paper remaining.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to printer systems, and particularly to a method and system for managing printer paper conditions.

2. Description of Background

Many point-of-sale (POS) printer devices are able to detect whether paper is present in the printer system. In some implementations, a pink margin is printed at the end of the paper roll to inform a user that the paper is running low. In this instance, a cashier is given an opportunity to prepare the POS system to receive a new paper roll. However, with recent shifts toward self-service POS systems (e.g., kiosks, and self-checkout systems), a customer would not be expected to detect the pink margin and replace the paper roll as needed. As a result, low paper conditions are monitored by individuals in order to determine when a replacement paper roll is needed. This is largely a manual process that involves physical inspection of the POS system.

What is needed, therefore, is an automated system for monitoring paper conditions at a POS device and taking appropriate actions based upon detected conditions.

### SUMMARY OF THE INVENTION

The shortcomings of the prior art are overcome and additional advantages are provided through the provision of a method for managing printer paper conditions is provided. The method includes monitoring states of a paper source in a point-of-sale (POS) printer by a light source and sensor mounted in the paper source, the light source emitting light. A low paper state is determined when a low reflection is detected by the sensor, the low reflection resulting from light reflected off of a colored portion of a paper roll when the light source and the sensor are mounted on the same side of the paper roll. The colored portion is provided along a margin at the low end of the paper roll. The method further includes tracking a motor step count of the paper source in response to the low paper state to determine a current amount of paper remaining on the paper roll, and transmitting a notification to a system that manages the POS printer informing the system of the current amount of paper remaining.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which automates the monitoring of paper conditions at a POS device, as well as actions taken in response to detected conditions.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a block diagram of a system for managing printer paper conditions at a point-of-sale (POS) device in exemplary embodiments; and

FIG. 2 illustrates one example of a flow diagram describing a process for managing printer paper conditions at a POS device in exemplary embodiments.

The detailed description explains the preferred embodiments of the invention, together with advantages and features, by way of example with reference to the drawings.

### DETAILED DESCRIPTION OF THE INVENTION

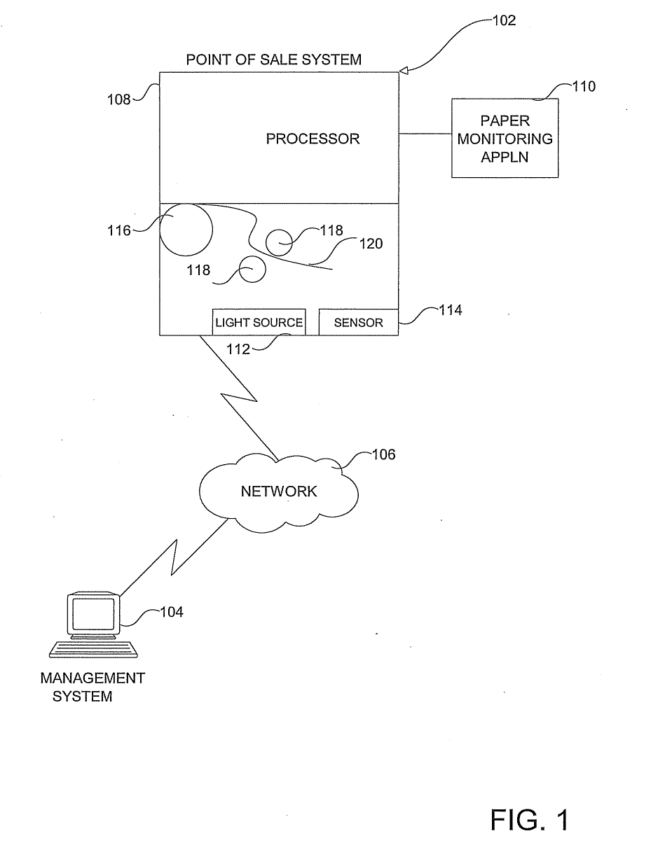

Turning now to the drawings in greater detail, it will be seen that in FIG. 1, there is a system upon which printer paper management activities may be implemented ill exemplary embodiments. The system of FIG. 1 includes a point-of-sale (POS) system 102 in communication with a management system 104 over a network 106. POS system 102 refers to an automated, self-service purchasing device (e.g., kiosk, self-checkout system) whereby customers may purchase items without human intervention from a selling enterprise. POS system 102 includes a processor 108, light source 112, sensor 114, paper roll 116, and paper feeds 118.

Processor 108 may comprise any type of computer processing device known in the art. Light source 112 is mounted within the POS system 102 and emits light. Light source 112 may be implemented via a light emitting diode (LED) or similar item. Sensor 114 refers to a photosensing device that detects light. Sensor 114 receives light generated via light source 112 as described herein. As shown in FIG. 1, light source 112 and sensor 114 are mounted on the same side of a paper roll 116 (adjacent).

As shown in FIG. 1, the length of paper 120 is disposed between two paper feeds 118 extending from the paper roll 116. As the paper 120 passes in front of the light source 112, the light emitted from light source 112 reflects off of the paper 120 and is received at the sensor 114. If the paper roll is not low, the sensor will detect a high reflection of light (due to the white color of the paper). If the paper roll is low, the sensor 114 will detect a low reflection of light (due to, e.g., a pink or colored portion of the paper). If there is no paper left on the paper roll 116, the sensor 114 will detect no reflection of light (as there is no intervening object from which the light may reflect.

In alternative exemplary embodiments, the light source 112 and the sensor 114 may be mounted on opposing sides of the paper roll 116 (not shown). As the paper 120 passes in front of the light source 112, the light emitted from light source 112 passes through the paper 120 to the sensor 114. If the paper roll is not low, the sensor will detect a low light reception (e.g., due to the paper obscuring a portion of the light emitted from the light source 112). If the paper roll is low, the sensor 114 will detect no light reception (due to, e.g., a pink or colored portion of the paper). If there is no paper left on the paper roll 116, the sensor 114 will detect a high light reception (as there is no intervening object obscuring the light emitted from the light source 112).

POS system 102 also includes a motor (not shown) that drives the paper 120 through the paper feeds 118 and through the system 102.

The processor 108 executes a paper monitoring application 110 for implementing the paper condition monitoring activities described herein. The paper monitoring application 110 generates notifications regarding paper conditions (i.e., paper states) detected and transmits the notifications to a management system, such as management system 104 over network 106 for action, if needed.

Management system 104 may be implemented using a computer processing device, e.g., a personal computer, that is operated by an individual that is responsible for maintaining the operation of the POS system 102 and that the light source 112 and sensor 114 are mounted on the same side of the paper roll as shown in FIG. 1.

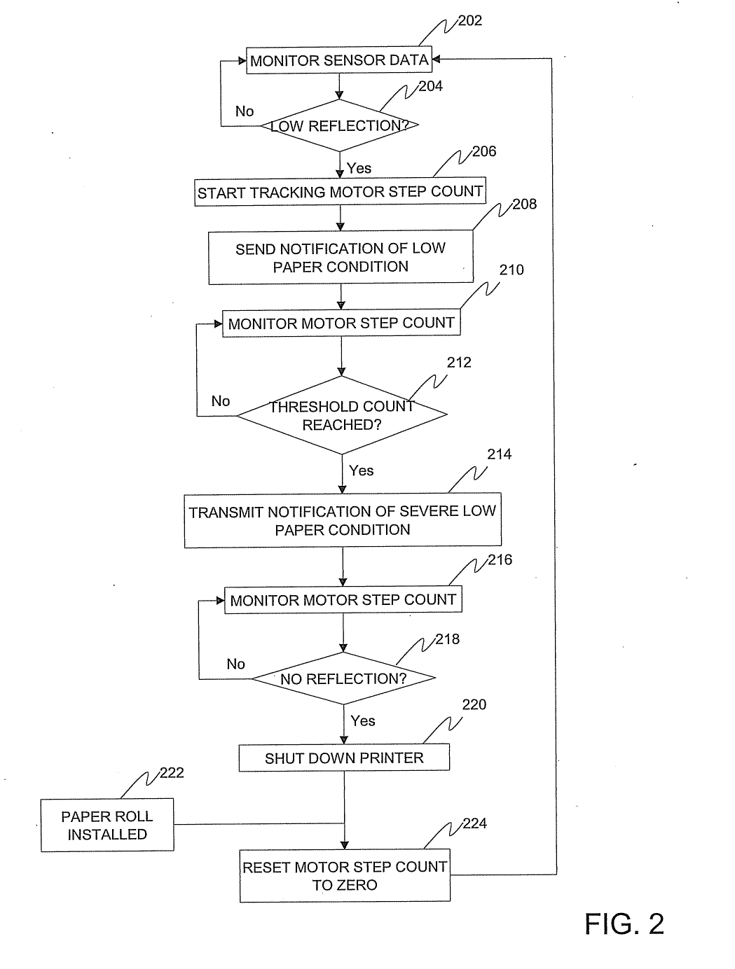

Turning now to FIG. 2, a flow diagram describing a process for implementing the printer paper management activities will now be described in exemplary embodiments. The process described in FIG. 2 assumes that a new paper roll has been installed in the POS system 102.

At step 202, the paper monitoring application 110 monitors the sensor data received from sensor 114 (e.g., low reflection, high reflection, no reflection). It is determined whether a low reflection condition is present (e.g., pink or colored paper) as a result of the monitoring at step 204. If not, the process returns to step 202 whereby the sensor data continues to be monitored. Otherwise, if a low reflection condition is determined at step 204, the paper monitoring application 110 begins to track the motor step count of the motor within POS system 102 at step 206. The motor step count may be implemented by tracking a number of revolutions of the motor, each of which translates to a length of paper extracted from the paper roll 116. This motor step count, coupled with the length of paper contained in the paper roll enables the paper monitoring application 110 to determine an amount of paper remaining on the paper roll 116. If the paper roll is replaced at anytime, i.e., white paper is detected, then the motor step count will be reset at step 224.

At step 208, the paper monitoring application 110 generates a notification indicating a low paper condition and transmits the notification to management system 104 via network 106. The paper monitoring application 110 continues to monitor the motor step count and the sensor data at step 210.

At step 212, it is determined whether a threshold motor step count has been reached. This may be implemented by determining an amount of paper that is originally present on the paper roll 116 and calculating the remaining amount of paper based upon a number of motor step counts, each of which translate to a length of paper on the paper roll 116. If the threshold count has not been reached, the motor step count continues to be monitored at step 210. Otherwise, the paper monitoring application 110 generates and transmits a notification of a severe low paper condition at step 214 and the motor step count and sensor data continues to be monitored at step 216. Optionally, additional paper roll indicator, e.g., a percentage of paper roll left can also be transmitted.

At step 218, it is determined whether no reflection is detected by the sensor indicating that the paper has run out. If not, the process returns to step 216. Otherwise, the paper monitoring application 110 causes a printer portion of the POS system 102 to optionally shut down at step 220. This may be performed to avoid damage to printing elements that are otherwise compromised when performing printing actions without paper present.

When a new paper roll 116 is installed at step 222, the printer portion is initialized, the motor step count is reset to zero at step 224 and the process returns to step 202 whereby sensor data is again monitored.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for managing printer paper conditions, comprising:
monitoring states of a paper source in a point-of-sale (POS) printer by a light source and sensor mounted in the paper source, the light source emitting light, wherein:
a low paper state is determined when a low reflection is detected by the sensor, the low reflection resulting from light reflected off a colored portion of a paper roll when the light source and sensor are positioned on the same side of the paper roll, the colored portion provided along a margin at the low end of the paper roll;
a low paper state is determined when no light reception is detected by the sensor, the no reception resulting from a lack of light passing through a colored portion of a paper roll when the light source and sensor are on opposing sides of the paper roll, the colored portion provided along a margin at the low end of the paper roll;
tracking a motor step count of the paper source in response to the low paper state to determine a current amount of paper remaining on the paper roll; and
transmitting a notification to a system that manages the POS printer informing the system of the current amount of paper remaining;
wherein detection of paper states is accomplished using the same sensor.

2. The method of claim 1, wherein further, a severe low paper state is determined when the motor step count reaches a pre-defined threshold, the method further comprising at least one of:
transmitting a notification to the system informing the system of the severe low paper condition; and
optionally shutting down the POS printer until a new paper roll is installed.

3. The method of claim 1, wherein the paper states include a no paper state; wherein:
the no paper state is determined when no reflection is detected by the sensor and when the light source and the sensor are positioned on the same side of the paper roll, the no reflection resulting from light emitted directly from the light source with no intervening paper from which the light reflects; and
the no paper state is determined when a high light reception is detected by the sensor and when the light source and the sensor are positioned on opposing sides of the paper roll, the high light reception resulting from light emitted directly from the light source to the sensor with no intervening paper to reflect the light.

4. The method of claim 1, wherein the paper states include a normal paper state; wherein:
the normal paper state is determined when a high reflection is detected by the sensor and when the light source and the sensor are positioned on the same side of the paper roll, the high reflection resulting from light reflected off of a non-colored portion of a paper roll; and
the normal paper state is determined when a low light reception is detected by the sensor and when the light source and the sensor are positioned on opposing sides of the paper roll, the low light reception resulting from light passing through the paper to the sensor.

5. The method of claim 4, further comprising:
resetting the motor step count when the normal paper state is determined.

6. A system for managing printer paper conditions, comprising:
a networked processing device; and
a paper monitoring application executing on the networked processing device, the paper monitoring application performing a method, comprising:
monitoring states of a paper source in a point-of-sale (POS) printer by a light source and sensor mounted in the paper source, the light source emitting light, wherein:
a low paper state is determined when a low reflection is detected by the sensor, the low reflection resulting from light reflected off a colored portion of a paper roll when the light source and the sensor are positioned on the same side of the paper roll, the colored portion provided along a margin at the low end of the paper roll;
a low paper state is determined when no light reception is detected by the sensor, the no reception resulting from a lack of light passing through a colored portion of a paper roll When the light source and the sensor are positioned on opposing sides of the paper roll, the colored portion provided along a margin at the low end of the paper roll;
tracking a motor step count of the paper source in response to the low paper state to determine a current amount of paper remaining on the paper roll; and
transmitting a notification to a system that manages the POS printer informing the system of the current amount of paper remaining;
wherein detection of paper states is accomplished using the same sensor.

7. The system of claim 6, wherein further, a severe low paper state is determined when the motor step count reaches a pre-defined threshold, the method further comprising at least one of:
transmitting a notification to the system informing the system of the severe low paper condition; and
optionally shutting down the POS printer until a new paper roll is installed.

8. The system of claim 6, wherein the paper states include a no paper state; wherein:
the no paper state is determined when no reflection is detected by the sensor and when the light source and the sensor are positioned on the same side of the paper roll, the no reflection resulting from light emitted directly from the light source with no intervening paper from which the light reflects; and
the no paper state is determined when a high light reception is detected by the sensor and when the light source and the sensor are positioned on opposing sides of the paper roll, the high light reception resulting from light emitted directly from the light source to the sensor with no intervening paper to reflect the light.

9. The system of claim 6, wherein the paper states include a normal paper state, wherein:
the normal paper state is determined when a high reflection is detected by the sensor and when the light source and the sensor are positioned on the same side of the paper roll, the high reflection resulting from light reflected off of a non-colored portion of a paper roll; and
the normal paper state is determined when a low light reception is detected by the sensor and when the light source and the sensor are positioned on opposing sides of the paper roll, the low light reception resulting from light passing through the paper to the sensor.

10. The system of claim 9, wherein the paper monitoring application further performs: resetting the motor step count when the normal paper state is determined.
